(19) United States
(12) Patent Application Publication
(10) Pub. No.: US 2013/0282677 A1
(43) Pub. Date: Oct. 24, 2013

(54) DATA COMPRESSION SYSTEM FOR DNA SEQUENCE

(71) Applicants: Zhen Ji, Shenzhen (CN); Jiarui Zhou, Shenzhen (CN); Zexuan Zhu, Shenzhen (CN); Ying Chu, Shenzhen (CN)

(72) Inventors: Zhen Ji, Shenzhen (CN); Jiarui Zhou, Shenzhen (CN); Zexuan Zhu, Shenzhen (CN); Ying Chu, Shenzhen (CN)

(21) Appl. No.: 13/978,408

(22) PCT Filed: Dec. 27, 2011
(86) PCT No.: PCT/CN11/84708

§ 371 Date: Jul. 5, 2013

(30) Foreign Application Priority Data
Jan. 7, 2011 (CN) 201110002601.2

(51) Int. Cl. G06F 19/10

(52) U.S. Cl. CPC G06F 19/10
USPC 707/693

(57) ABSTRACT

The present invention discloses a data compression system for DNA sequence, which is a lossless compression system for DNA sequence data, based on the MA-ARV codebook, which is able to search the approximate repeat fragment of the MA-ARV code vector in the whole sequence, and use a heuristic optimization algorithm of memetic algorithm to optimize the construction process of the compressed codebook, so as to fully use the repeat nature of DNA sequence data, and eliminate the redundancy effectively.

### FIELD OF THE INVENTION

The present invention relates to the field of data compression, and more particularly, to a lossless data compression system for DNA sequence based on memetic algorithm and approximate repeat vector model.

### BACKGROUND

DNA is a double chain polymer in the cells of any species, used to store the genetic instructions information, which is an important material basis for the survival, continuation and development of most species. DNA sequence data is the abstract bioinformatics model on DNA substances, which contains the whole genetic information, has important scientific value and social significance. In order to obtain the genetics information of a variety of species, various of DNA sequencing projects have been started one after another, and huge amount of DNA sequence data has been generated, which has brought great pressure to the present resources used for data storage and transmission. Therefore, a compression operation is needed to DNA sequence data. Since by these days, the whole information contained in DNA has not yet been totally understood by the academia, thus only a lossless compression method can be applied. On the other hand, since a DNA sequence owns distinctive biological data characters, a traditional generic compression algorithms is unable to encode it effectively, thus some compression methods specifically for DNA sequence data have been created accordingly.

A typical existing DNA sequence data compression method is BioCompress-2 system, which is the first practical data compression system for DNA sequence, and is also the basis for following improved systems.

A DNA sequence is a series of data in one dimensional long character string, composed by four base symbols recorded as, A (Adenine), T (Thymine), C (Cytosine), G (Guanine). If their biological meanings are not taken into account, they can be considered as plain text data for compression encoding. In BioCompress-2, a general LZ compression algorithm is induced to encode the input data. The LZ compression algorithm is able to eliminate the redundant data in plain text effectively. However, a DNA sequence has its special data structure, whose data amount often gets increased if it is only encoded by the LZ compression algorithm. To solve this problem, BioCompress-2 system induces a processing method which compares the data amount before and after encoding. Only when the data amount has an actual decrease after being compressed by the LZ compression algorithm, will an encoding operation be executed to the input DNA sequence data, otherwise, the original data will be kept as it is. Also, when the BioCompress-2 system executes the compression encoding, it will not only search the direct repeat fragments, but also look for the longest palindrome repeat sequence. Through summarizing the redundant information in the input data by using a direct repeat model as well as a palindrome repeat model in the gliding window range, Biocompress-2 algorithm can improve the compression performance on DNA sequence effectively.

However, the BioCompress-2 system and other improved data compression system for DNA sequence based on it, usually have three major defects:

Firstly, the system describes the redundant data only with direct repeat model and palindrome repeat model, which are not enough to cover all the characters in the sequence data. Thus, in data compression process, there are still a big number of repeated fragments not been encoded due to their repeat patterns are not considered. Therefore, the compression effect gets affected.

Secondly, BioCompression-2 system takes account of the exact repeat data only, during matching process. However, a DNA sequence comes from actual genetic materials within a biological cell, which can generate a lot of mutations and damages for base symbol during duplication, crossover and evolution processes. Thus, the repeat in DNA sequence exists in the form of approximate repeat. Therefore, since the compression system searches for the exact repeat fragments only, a lot of approximate repeat redundant data will be omitted.

Thirdly, when executing compression encoding with LZ algorithm, the searching range is the partial sequence in the gliding window buffering area only. While the DNA sequence data, coming from the real biological substances, are different to the plain text data, whose large scale repeat data can more possibly appear at locations farther to each other, which has been beyond the covering area of the sliding window of a general LZ compression algorithm. Thus, during searching, LZ compression algorithm can find small scale repeat fragments only, and this often makes the amount of the encoded data expand. It has greatly limited the compression performance of the BioCompress-2 system.

Therefore, the prior art needs to be improved and developed.

### BRIEF SUMMARY OF THE DISCLOSURE

The technical problems to be solved in the present invention is, aiming at the defects of the prior art, providing a data compression system for DNA sequence, in order to solve the problems in the prior art.

The technical solution adopted in the present invention to solve the technical problems is as below:

A data compression system for DNA sequence, wherein, the said data compression system for DNA sequence includes:

An MA-ARV codebook designing module, configured to construct a compression codebook for the present input DNA sequence data;

A DNA sequence data compression module, configured to execute a lossless compression encoding operation to the present input DNA sequence data based on the MA-ARV codebook ; and

A DNA sequence data decompression module, configured to decompress the compressed data file and recover the original data.

The said data compression system for DNA sequence, wherein, the said data compression system for DNA sequence further includes an input module, a checking module and an output module;

The said input module, checking module and DNA sequence data compression module are connecting to the output module in sequence, the said checking module also connects to the MA-ARV codebook designing module and the DNA sequence data decompression module separately, and the said MA-ARV codebook designing module connects to the DNA sequence data compression module.

The said data compression system for DNA sequence, wherein, the said MA-ARV codebook designing module expresses the current input DNA sequence data as an MV-ARV vector v, whose redundancy fragment with direct repeat pattern is expressed as the same vector v, the fragment with mirror repeat is expressed as vector v⁻¹; according to the base pairing principle, the fragment with pairing repeat is expressed as vector v*, and an inverted repeat fragment is expressed as vector v^{-1*}.

The said data compression system for DNA sequence, wherein, when the said data compression system for DNA sequence is compressing data, the encoding format used is {id, repeat type, {edit error}}, wherein, the said id means a code vector number according to MA-ARV, the said repeat type means the repeat pattern, the said edit error means a sequence of edit error information.

The said data compression system for DNA sequence, wherein, the said sequence of editing error information is encoded in a format of {offset, edit type, symbol}; wherein, the said offset is the position for edit operation to the base, the said edit type is the operation type symbol: the said S means substitute, the said D means delete, the said I means insert, the said symbol means the base symbol in operation.

A data compression method for DNA sequence, wherein, it includes the following steps:

S100, input a data;

S200, check if the input data is the original DNA sequence data, if so, execute S300, otherwise, go to S400;

S300, check if the input data contains an MA-ARV codebook, if so, execute S311, otherwise, go to S321;

S311, go into the DNA sequence data compression module, encode the input data with lossless compression based on the MA-ARV codebook;

S312, output the compressed DNA sequence data finally;

S321, go into the MA-ARV codebook designing module, construct a compression codebook according to the current input DNA sequence data, then execute S311;

S400, go into the DNA sequence data decompression module, and decompress the compressed data file and recover the original data; and

S410, finally output the decompressed and recovered original DNA sequence data.

Beneficial effects: the present invention provides a lossless compression system for DNA sequence data, based on an MA-ARV codebook. The system is able to search the approximate duplicate fragment of the MA-ARV code vector in the whole sequence, and use a heuristic optimization algorithm of memetic algorithm to optimize the construction process of the compressed codebook, so as to fully use the repetitive nature of DNA sequence data, eliminate redundancy effectively, and improve the overall compression ratio.

### BRIEF DESCRIPTION OF THE DRAWINGS

FIG. 1 illustrates a schematic diagram of the DNA sequence with a direct repeat pattern.

FIG. 2 illustrates a schematic diagram of the DNA sequence with a mirror repeat pattern.

FIG. 3 illustrates a schematic diagram of the DNA sequence with a pairing repeat pattern.

FIG. 4 illustrates a schematic diagram of the DNA sequence with an inverted repeat pattern.

FIG. 5 illustrates a schematic diagram of the MA-MRV vector model v.

FIG. 6 illustrates a schematic diagram of the direct repeat pattern v of the MA-MRV vector model v.

FIG. 7 illustrates a schematic diagram of the mirror repeat pattern v⁻¹ of the MA-MRV vector model v.

FIG. 8 illustrates a schematic diagram of the pairing repeat pattern v* of the MA-MRV vector model v.

FIG. 9 illustrates a schematic diagram of the inverted repeat pattern v⁻¹* of the MA-MRV vector model v.

FIG. 10 illustrates a schematic diagram of encoding the editing error of the MA-ARV vector model v.

FIG. 11 illustrates a block diagram of the data compression system for DNA sequence.

FIG. 12 illustrates a flow diagram of the data compression system for DNA sequence based on MA-ARV.

FIG. 13 illustrates a diagram of DNA sequence data compression and encoding, based on a dictionary.

### DETAILED DESCRIPTION

The present invention provides a data compression system for DNA sequence, In order to make the purpose, technical solution and the advantages of the present invention clearer and more explicit, further detailed descriptions of the present invention is stated here. It should be understood that the detailed embodiments of the invention described here are used to explain the present invention only, instead of limiting the present invention.

Comparing to a plain text character string, DNA sequence data owns the following three major significant characters:

Firstly, a DNA sequence data contains a big number of similar redundancies. Wherein, there are some simple fragments repeating, as well as some large scale genetic sequence duplications. The high similarity in DNA sequence data is the fundamental basis of its compression algorithm. Theoretically, if a data model having a coverage ability good enough to describe the redundancy in the DNA sequence data is applied, a higher compression ratio can be achieved.

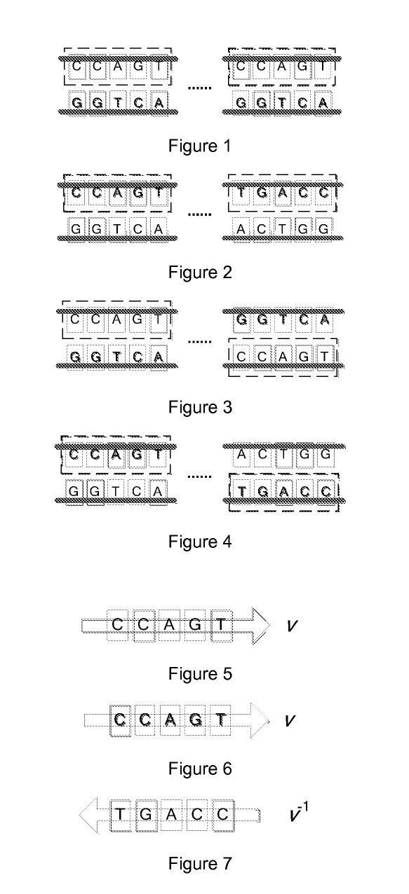

Secondly, repeat in the DNA sequence data has a plurality of unique patterns. As showed in FIG. 1 to FIG. 4, the similar fragments in the DNA sequence has the common direct repeat pattern, as well as some unique patterns including the mirror repeat pattern, pairing repeat pattern, inverted repeat pattern and more, wherein, the inverted repeat is the palindrome repeat, used in the BioCompress-2 algorithm. Direct repeat pattern is widespread in the general character string data, while the mirror repeat pattern is relatively rare, and the last two patterns are unique to DNA sequence data, due to the special double-chain structure and base pairing principle of DNA.

Thirdly, repeat in the DNA sequence is expressed in the form of approximate repeat more often, that is, it can be considered as achieved by a certain number of editing operations, including base insertion, deletion and substitution, to the exact repeat fragments in all patterns. This kind of approximate repeat character is decided by the biological property of DNA substances.

From the analysis described above, traditional compression systems including BioCompress-2, uses only a very small part in these unique data characters, which limits the improvement of its compression capacity.

In order to solve this problem, the present invention of the data compression system for DNA sequence summarizes the repeat characters of the DNA sequence data, and provides a redundant description model on memetic algorithm based approximate repeat vector, (MA-ARV), used to cover and process the similar fragments in DNA sequence uniformly.

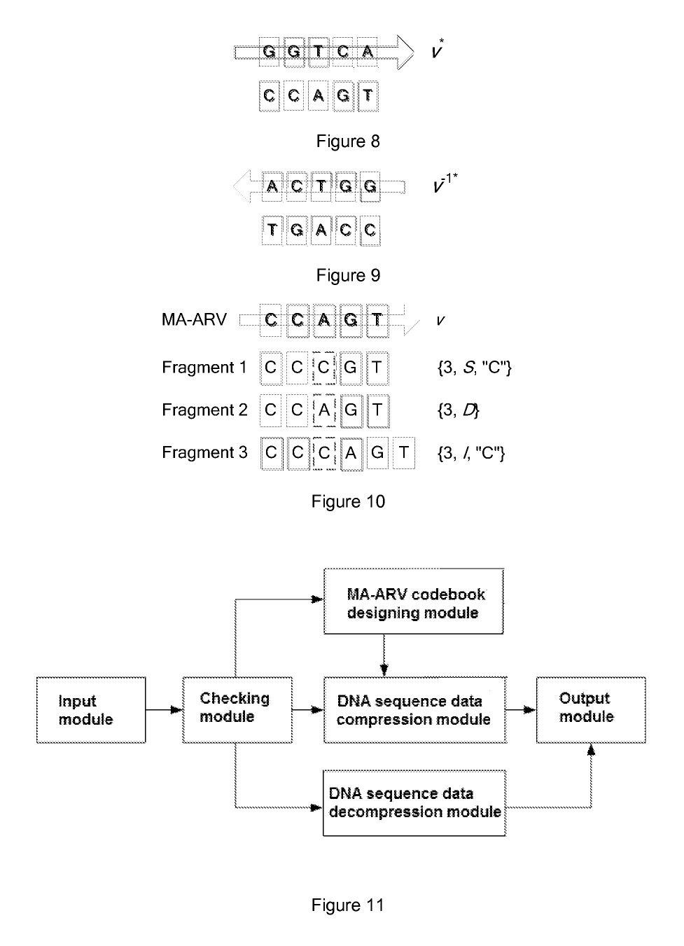

MA-ARV means the directed sequence substring with four repeat patterns designed by Memetic Algorithm (MA). As shown in FIG. 5 to FIG. 9, for a MA-ARV vector v of the DNA sequence data, its redundant fragment with direct repeat pattern can be expressed as the same vector v, and the fragment with mirror repeat pattern as the vector v⁻¹; According to the base pairing principle, the fragment with pairing repeat pattern is expressed as vector v*, and a vector v⁻¹* expressing the inverted repeat fragment. Here, the superscript “−1” means reverse of the base symbol sequence, and superscript “*” means the complementary base pairing. Thus during the searching process, fragments with four repeat patterns in the DNA sequence data, can be described with the same MA-ARV model uniformly. And during compressing encoding, these four kinds of repeat fragments need only the according single MA-ARV sequence to be recorded.

During compressions, the repeat fragments in the MA-ARV sequence can be encoded in the format of {id, repeat type}. Wherein, the said id means the MA-ARV sequence number according to the repeat fragments, the said repeat type is the type of repeat pattern: the said D means direct repeat, the said M means mirror repeat, the said P means pairing repeat, the said I means inverted repeat.

For similar DNA repeat fragments, MA-ARV will encode their base editing error information separately. As shown in FIG. 10, for a known MA-ARV sequence v, the editing error of its approximate repeat fragments can be encoded in a format of {offset, edit type, symbol}. Wherein, the said offset is the position for edit operation to the base, the said edit type is the operation type symbol: the said S means substitute, the said D means delete, the said I means insert, and the said symbol means the base symbol in operation.

For example, there is an MA-ARV sequence in the FIG. 10:

v = “CCAGT”

So, to the repeat Fragment 1, it can be considered as substituting the third symbol “A” in the MA-ARV vector v with a base “C”, that is, its error can be encoded as {3, S, “C”}. Other two Fragments 2 and 3 can also be encoded as {3, D} and {3, I, “C}. Wherein, when vector v is transforming to Fragment 2, its third symbol “A” is the redundancy base for deleting, thus only the delete operation symbol D needs to be recorded.

The MA-ARV model covers the three major data characters in DNA repeat fragments, which can describe the redundancy information in the sequence data more completely.

The data compression system for DNA sequence in the present invention uses the compression method based on dictionaries, and induces the MA-ARV model into the encoding process of the DNA sequence data. The data compression system for DNA sequence mainly contains three functional modules: 1. An MA-ARV codebook designing module, configured to construct a compression codebook for the current input DNA sequence data; 2. A DNA sequence data compression module, mainly configured to execute a lossless compression encoding operation to the current input data, based on the MA-ARV codebook; 3. A DNA sequence data decompression module, configured to decompress the compressed data file and recover the original data.

The said data compression system for DNA sequence further includes an input module, a checking module and an output module; the said input module, checking module and DNA sequence data compression module are connecting to the output module in sequence, the said checking module also connects to the MA-ARV codebook designing module and the DNA sequence data decompression module separately, and the said MA-ARV codebook designing module connects to the DNA sequence data compression module.

The said input module is configured to input the DNA sequence data, the said checking module is used to check if the input is the original DNA sequence data and check if the input data contains MA-ARV codebooks, the said output module is configured to output the compressed DNA sequence data or decompressed and recovered original DNA sequence data.

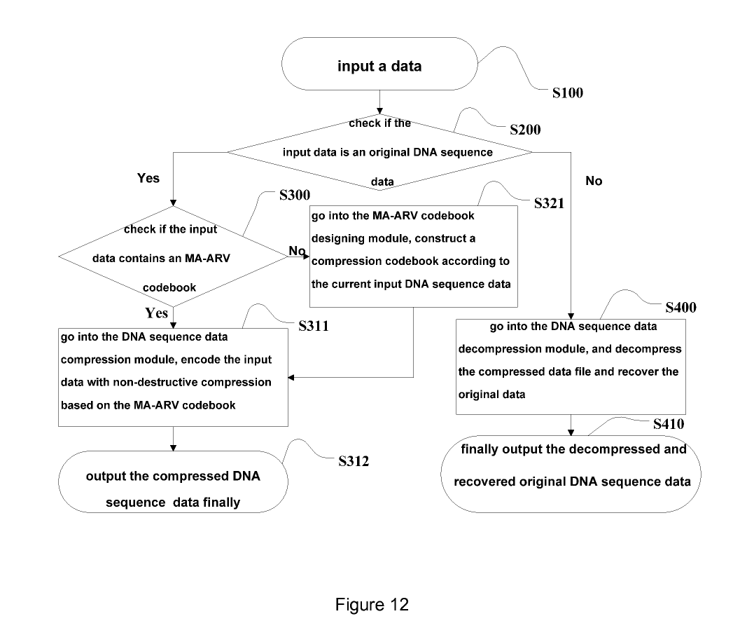

A data compression encoding method for DNA sequence based on dictionaries is shown in FIG. 12:

S100, input a data;

S200, check if the input data is the original DNA sequence data, if so, execute S300, otherwise, go to S400;

S300, check if the input data contains an MA-ARV codebook, if so, execute S311, otherwise, go to S321;

S311, go into the DNA sequence data compression module, encode the input data with lossless compression based on the MA-ARV codebook;

S312, output the compressed DNA sequence data finally;

S321, go into the MA-ARV codebook designing module, construct a compression codebook according to the current input DNA sequence data, then execute S311;

S400, go into the DNA sequence data decompression module, and decompress the compressed data file and recover the original data; and

S410, finally output the decompressed and recovered original DNA sequence data.

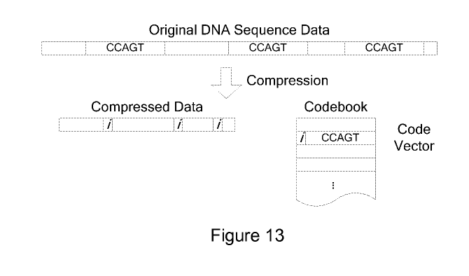

The compression principle of the present invention on the data compression system for DNA sequence is shown in FIG. 13, suppose that there is a group of approximate repeat fragments of the MA-ARV contained in the original DNA sequence data. The approximate repeat fragments include all four repeat patterns. Then the MA-ARV code designing module will search for all the locations, patterns and editing errors information of the repeat fragments in the whole DNA sequence. Then, considering this group of MA-ARM sequence as the code vector and constructing the compression codebook, the algorithm substitutes the original sequence fragment by using the according code vector sequence numbers of the repeat fragment as well as their editing error information, in order to achieve the goal of eliminating redundancy data. The present invention system uses a heuristic optimization algorithm of memetic algorithm to optimize the construction and designing process of the MA-ARV compressing codebook.

During the data compressing process, the system of the present invention uses a coding format of {id, repeat type, {edit error}}, wherein, the said id means a vector number according to the MA-ARV code, the said repeat type means the repeat pattern, and the said edit error means an editing error information sequence. For example, when the MA-ARV locates at number i, its code vector is:

vᵢ = “CCAGT”

and there is a following fragment in the original DNA sequence data:

“. . . TTCTGACTCAA . . .”

which can be recognized as the fragment containing the following sequence:

I = “TGACTC”

This fragment can be considered an approximate repeat fragment to the MA-ARV vector vᵢ, thus, it can be recorded as:

“ . . . TTC {i, M, {2, I, “T”}} AA . . . ”

Thus, this means the encoding part is the mirror repeat fragment of the MA-ARV code vector vᵢ with the code number i, which can be achieved through editing operations by inserting symbol “T” to the second base position of the code vector

Since the MA-ARV model describes the DNA sequence data redundancies effectively, and the compression algorithm based on dictionaries can search the repeat fragments of the MA-ARV code vector at all positions, thus the present method covers the major data similarity characters of the DNA sequence, thus it is possible to achieve higher compression ability than the traditional method.

In decompressions, it is only needed to execute substitutions, and recover the original DNA sequence data, based on the compression codebook and editing error information.

The major advantages generated by the present invention on the data compression system for DNA sequence, provided in the present invention, mainly include:

Firstly, based on summarizing the unique DNA sequence data repeat characters, an MA-ARV data model with a better summarizing ability is presented, to describe the redundancy information of the sequence. Through applying it to the compression encoding process of the DNA sequence data, it is possible to fully cover the unique data characters of the DNA sequence data, search and match more repeat fragments, and record with a unified MA-ARV code vector. Therefore, the present invention improves the compression performance effectively.

Secondly, the present invention provides a lossless compression system for DNA sequence data, based on an MA-ARV codebook, which is able to search the approximate repeat fragment of the MA-ARV code vector in the whole sequence, and use a heuristic optimization algorithm of memetic algorithm to optimize the construction process of the compressed codebook, so as to fully use the repeat nature of the DNA sequence data, eliminate redundancy effectively, and improve the compression ratio.

It should be understood that, the application of the present invention is not limited to the above examples listed. It will be possible for a person skilled in the art to make modifications or replacements according to the above description. All of these modifications or replacements shall all fall within the scope of the appended claims of the present invention.

What is claimed is:

1. A data compression system for DNA sequence, wherein, the said data compression system for DNA sequence comprises:
An MA-ARV codebook designing module, configured to construct a compression codebook for a current input DNA sequence data;
A DNA sequence data compression module, configured to execute a lossless compression encoding operation to the current input DNA sequence data based on a MA-ARV codebook; and
A DNA sequence data decompression module, configured to decompress the compressed data file and recover the original data.

2. The said data compression system for DNA sequence according to claim 1, wherein, the said data compression system for DNA sequence further comprises an input module, a checking module and an output module;
The said input module, checking module and DNA sequence data compression module are connecting to the output module in sequence, the said checking module also connects to the MA-ARV codebook designing module and the DNA sequence data decompression module separately, and the said MA-ARV codebook designing module connects to the DNA sequence data compression module.

3. The said data compression system for DNA sequence according to claim 1, wherein, the said MA-ARV codebook designing module expresses the current input DNA sequence data as an MV-ARV vector v, a direct repeat pattern redundancy fragment of the said MV-ARV vector v is expressed as the same vector v, a mirror repeat pattern fragment is expressed as vector v⁻¹; according to the base pairing principle, a pairing repeat pattern fragment is expressed as vector v*, and an inverted repeat fragment is expressed as vector v⁻¹*.

4. The said data compression system for DNA sequence according to claim 1, wherein, when the said data compression system for DNA sequence is compressing data, the encoding format used is {id, repeat type, {edit error}}, wherein, the said id means a code vector number according to the MA-ARV, the said repeat type means a repeat pattern, the said edit error means an editing error information sequence.

5. The said data compression system for DNA sequence according to claim 4, wherein, the said editing error information sequence is encoded in a format of {offset, edit type, symbol}; wherein, the said offset is the position for edit operation to the base, the said edit type is the operation type symbol: the said S means substitute, the said D means delete, the said I means insert, the said symbol means the base symbol in operation.

6. A data compression method for DNA sequence, comprising the following steps:
S100, input a data;
S200, check if the input data is an original DNA sequence data, if so, execute S300, otherwise, go to S400;
S300, check if the input data contains an MA-ARV codebook, if so, execute S311, otherwise, go to S321;
S311, go into the DNA sequence data compression module, encode the input data with lossless compression based on the MA-ARV codebook;
S312, output the compressed DNA sequence data finally;
S321, go into the MA-ARV codebook designing module, construct a compression codebook according to the current input DNA sequence data, then execute S311;
S400, go into the DNA sequence data decompression module, and decompress the compressed data file and recover the original data; and
S410, finally output the decompressed and recovered original DNA sequence data.
